(19) United States
(12) Patent Application Publication
(10) Pub. No.: US 2008/0320213 A1
(43) Pub. Date: Dec. 25, 2008

(54) CONTROL DEVICE OF NONVOLATILE MEMORY AND CONTROL METHOD THEREOF, AND STORAGE DEVICE

(75) Inventor: Tadaaki Kinoshita, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/146,034

(22) Filed: Jun. 25, 2008

(30) Foreign Application Priority Data
Jun. 25, 2007 (JP) 2007-166628

(51) Int. Cl. G06F 12/02

(52) U.S. Cl. 711/103; 711/166; 711/E12.008

(57) ABSTRACT

According to one embodiment, the overall information processing time can be shortened. There are provided (1) a logical/physical block address conversion table information section that associates a logical block address of a logical address space with a physical block address of a nonvolatile memory device, (2) a physical block use state management section and a physical block erase count management section to read out erase count information from a physical block of which the logical block address and the physical block address are not associated, and a physical block that satisfies a predetermined condition set related to the erase count information is selected as a selected physical block, and (3) a logical/physical block address conversion table management section that registers a physical block address of the selected physical block in the logical/physical block address conversion table.

### CROSS-REFERENCE TO RELATED APPLICATIONS

This application is based upon and claims the benefit of priority from Japanese Patent Application No. 2007-166628, filed Jun. 25, 2007, the entire contents of which are incorporated herein by reference.

### BACKGROUND

1. Field

One embodiment of the invention relates to a control device of a nonvolatile memory and a control method thereof, and a storage device. In particular, contrivance is made with respect to a method of managing the nonvolatile memory associated with the number of times of an erase operation.

2. Description of the Related Art

A NAND-type flash memory is known as a data rewritable nonvolatile memory. The data erase unit of the nonvolatile memory is one block (e.g., 128 kbytes). On the other hand, the data read and write units of the nonvolatile memory are each set to 2 kbytes.

When the number of times of the erase or write operation is increased, device degradation occurs to result in an increase in occurrence of data errors. To cope with this, the number of times of the write operation is set to, e.g., about one hundred thousand in order to guarantee the performance of the device. Accordingly, a function of managing the number of times of erasing a physical block is incorporated in a memory controller of the nonvolatile memory.

The memory control unit not only merely manages an erase count of each physical block, but also carries out averaging of the erase count of each physical block (for example, patent documents: U.S. Pat. No. 5,737,742 and Jpn. Pat. Appln. Publication No. 2006-235960). That is, at present, a physical block having a low erase count is selected and exchanged with a physical block having a high erase count.

However, in a conventional control method performed by a memory control unit, there is a problem that there is a large amount of information processing for each time the replacing processing of a physical block is carried out. That is, all information processing in a logical/physical block conversion table that associates a logical block with a physical block, and all information processing in a physical block erase count table are carried out every time physical blocks are exchanged. For this reason, there is a problem that managing processing of physical blocks is complicated, and also the processing time becomes longer. Further, there is a problem that, as the number of physical blocks to be processed for exchange becomes larger, this further lengthens the processing time.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an explanatory view of a configuration of a storage device to which the present invention is applied;

FIG. 2 is a view of a nonvolatile memory;

FIG. 3 is a view of a logical/physical block address conversion table;

FIG. 4 is an explanatory view showing a relationship between a physical block use state and physical block erase count data;

FIG. 5 is an explanatory view showing an example of a data area in a physical block;

FIG. 6 is a flowchart of an operation example of a device in the present invention, showing an operation example of when an appropriate physical block is selected from a plurality of physical blocks that can be optionally used; and

FIG. 7 is a flowchart showing an operation example of the device in the present invention.

### DETAILED DESCRIPTION

Various embodiments according to the invention will be described hereinafter with reference to the accompanying drawings.

An object of an embodiment of the present invention is to provide a control device of a nonvolatile memory and a control method thereof, and a storage device, which can facilitate management of a physical block, and thereby shorten the total information processing time.

In order to achieve the object described above, according to an aspect of the present invention, there is provided a memory control device that controls a nonvolatile memory having a limit of an erase count for each physical block unit and/or a programming count, including: a logical/physical block address conversion table information section that associates a logical block address of a logical address space used by a host device with a physical block address of a physical block of a nonvolatile memory; a physical block use state information section that stores information showing whether a physical block is associated with a logical block by the logical/physical block address conversion table information section; a physical block use state management section and a physical block erase count management section that use erase count information of a physical block in which the logical block address and the physical block address are not associated, and select a physical block as a first physical block that satisfies a predetermined condition set related to the erase count information; and a logical/physical block address conversion table management section that associates a physical block address of the first physical block with a logical block address and registers the associated physical block address in the logical/physical block address conversion table information section.

According to the above means, erase count information of a group of the physical blocks in which a logical block address and a physical block address are not associated is basically read out, and a physical block that satisfies a predetermined condition set in advance by the erase count information is selected and used. Therefore, the number of physical blocks to be managed can be small. For this reason, management of physical blocks can be facilitated, and therefore the overall information processing time becomes shorter. In addition, erase count information of a group of physical blocks in which a logical block address and a physical block address are associated is maintained by being described in redundant sections of physical blocks.

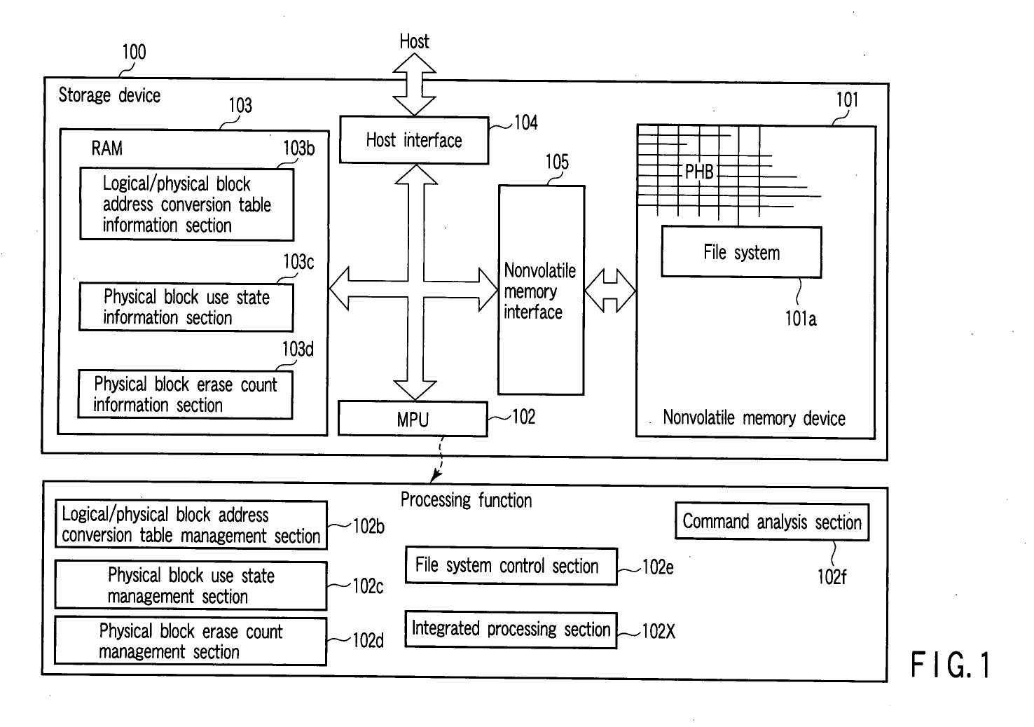

Hereinafter, with reference to the accompanying drawings specifically, an embodiment of the present invention will be described. First, a configuration of a storage device to which the present invention is applied is shown in FIG. 1 and described.

<Storage Device>

A storage device 100 has a nonvolatile memory device 101, a micro processing unit (hereinafter referred to as “MPU”) 102, a random access unit (hereinafter referred to as “RAM”) 103, a host interface 104, and a nonvolatile memory interface 105.

A storage area of the nonvolatile memory device 101 is configured with a number of physical blocks PHBs, and includes a file system 101a at a part of the storage area.

As a storage section set in the RAM 103, there are information sections as follows. There is a logical/physical block address conversion table information section 103b that has a table that has associated a logical block address with a physical block address. Further, the RAM 103 has a physical block use state information section 103c that stores a use state of physical blocks, and a physical block erase count information section 103d. In addition, although not shown, an area that develops a program to be executed by the MPU 102 is also secured.

The logical block address described above is a logical block address of a logical address space that is used by a host device. In addition, the physical block address is a physical block address in the nonvolatile memory device 101.

In addition, the physical block use state information section 103c described above registers a block address of a physical block that becomes in a state of being able to be used optionally. Here, an address of a physical block for which a logical block address and a physical block address are not associated is registered. The physical block erase count information section 103d stores each erase count of a physical block that can be optionally used and is registered in the physical block address use state information section 103c.

The physical block use state information, the logical/physical block address conversion table, a physical block address, and information such as a physical block erase count in the RAM 103 described above are managed and processed by a function of the MPU 102.

Therefore, the MPU 102 has the logical/physical block address conversion table management section 102b, the physical block use state management section 102c that stores a use state of a physical block, and the physical block erase count management section 102d. In addition, the MPU 102 has a file system control section 102e in the nonvolatile memory device 101, and an integrated processing section 102x that integrates these management sections. The integrated processing section 102x executes write and readout of data.

<Overall Operation>

If a command is input from a host via the host interface 104, the MPU 102 analyzes the command at a command analysis section 102f, and carries out processing that corresponds to a content of the command. At this time, a program developed in the RAM 103 is executed by the MPU 102.

If the analyzed command is a data write command, under control of the MPU 102, basically (1) the logical/physical block address conversion table information section 103b is referenced, and data write processing is executed with respect to a physical block address corresponding to a logical block address being designated.

Alternatively, (2) when the data write command is input, the following processing is carried out under control of the MPU 102. That is, information of the physical block use state information section 103c and the physical block erase count information section 103d is referenced, and an appropriate physical block is selected from a group of physical blocks that can be used optionally. Next, a logical block address sent from the host and the selected physical block address are associated on the logical/physical block address conversion table information section 103b, and at the same time, data write is carried out with respect to the selected physical block to the nonvolatile memory device 101 via the nonvolatile memory interface 105. At that time, the RAM 103 is used as a buffer as needed, such as for a read-modify-write with respect to the nonvolatile memory device 101.

Whether the item (1) or the item (2) described above is selected, and in what ratio processing of the item (1) and the item (2) is selected may be achieved in a variety of methods.

In addition, a variety of methods may be used for the timing to select a physical block that can be optionally used and modify the logical/physical block address conversion table. For example, such operation is executed when a write command is sent from a host. Alternatively, the above operation is executed when an update of a file system is carried out (at this time, there may be a number of physical blocks to be selected). Further, a method may be used such that the above operation is executed when an erase command is input from a host.

Preferably, as the timing to select a physical block that can be optionally used and modify the logical/physical block address conversion table, such operation is preferably executed after an update of a file system is carried out due to some factor, or at the same time as updating processing of the file system.

Then, the data storing processing when the data write command is input may follow the order in which the logical/physical block address conversion table information section 103b is referenced, and then data write processing is executed with respect to a physical block address corresponding to a logical block address being designated.

The above processing is equivalent to exchanging processing of a physical block to be used, and is averaging processing of an erase count of physical blocks. Further, the above processing is selection processing for selecting a physical block that is safe to be used. Further, management of a physical block is simple and high-speed information processing is achieved.

If the analyzed command is a data read command, a physical address with respect to a logical block address to be accessed is obtained by referencing the logical/physical block address conversion table information section 103b, data is read from the nonvolatile memory device 101 via the nonvolatile memory interface 105, and the data is transferred to a host via the host interface 104.

<Physical Block Use State on Nonvolatile Memory Device>

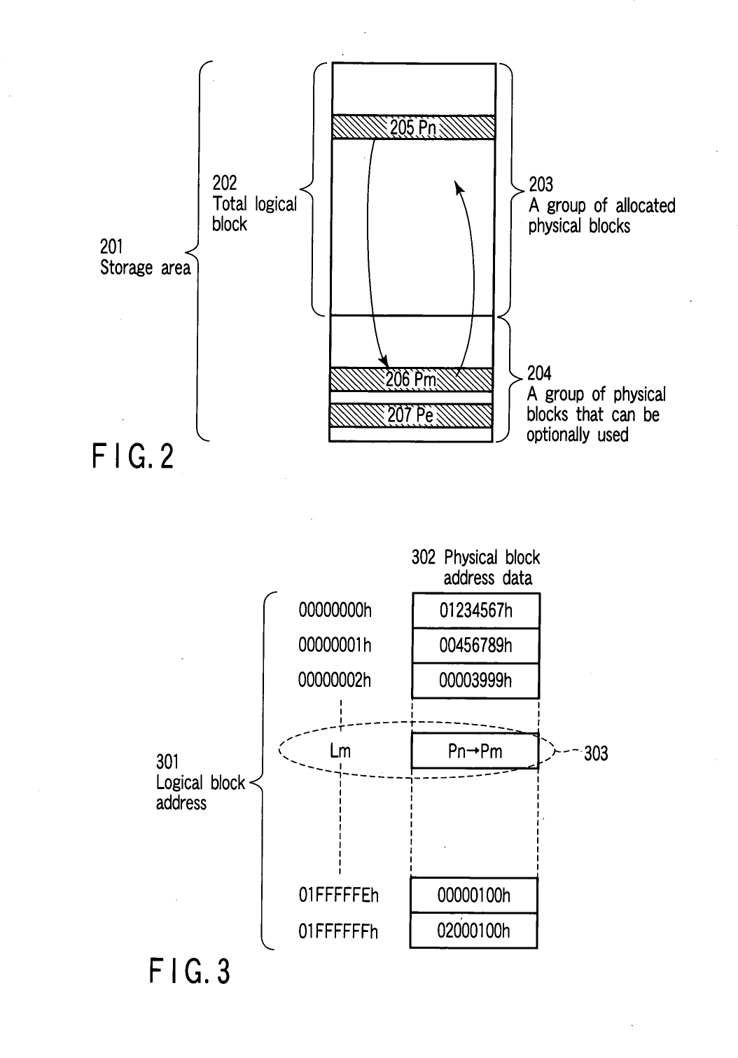

FIG. 2 shows an example of a storage area of the nonvolatile memory device and a use state thereof. A storage area 201 on the nonvolatile memory device 101 is configured with physical blocks throughout. Then, a part of the physical blocks is associated with logical blocks by the logical/physical block address conversion table information section 103b. These physical blocks are called allocated physical blocks 202. Here, unallocated physical blocks are called physical blocks 203, which can be optionally used.

<Logical/physical Block Address Conversion Table>

FIG. 3 is a view showing one example of the logical/physical block address conversion table 103b in FIG. 1. A logical block address 301 is equivalent to an offset address in a unit of 4 bytes starting from an optional address on the RAM 103, and physical block address data 302 associated with the logical block address 301 is stored in a data section. A section 303 enclosed by a dotted line will be described in detail later.

<Physical Block Use State Information and Physical Block Erase Count Information>

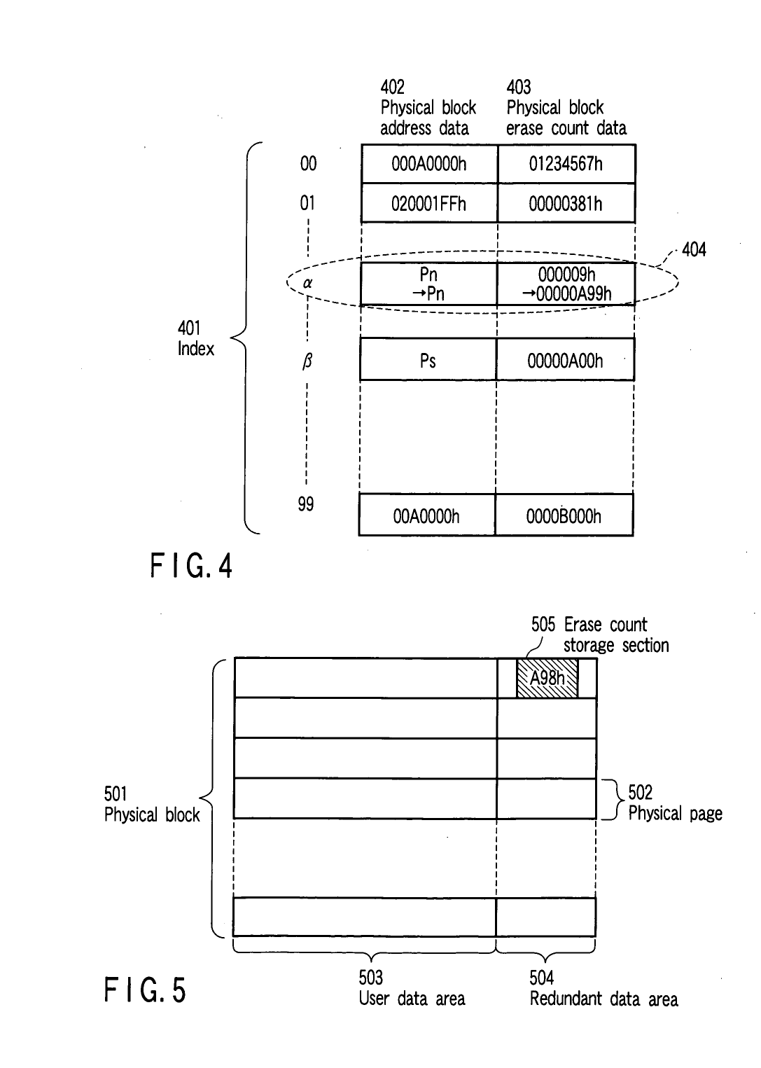

FIG. 4 is a view that explains one example of the physical block use state information section 103c and the physical block erase count information section 103d in FIG. 1. Physical block address data 402 has a data area in which all physical blocks shown by a numerical number 204 in FIG. 2 can be registered, and physical block erase count data section 403 has an erase count value corresponding to physical block address data stored therein. An index 401 is equivalent to an offset address for referencing the data section starting from an optional address on the RAM 103. A section 404 enclosed by a dotted line will be described in detail later.

In the description of FIG. 4, the physical block use state information section 103c and the physical block erase count information section 103d are described to manage only a group of the physical blocks 204 that can be optionally used in FIG. 2. However, the present invention is not limited thereto, and a group of the allocated physical blocks 203 and a group of the physical blocks 204 that can be optionally used may be classified, and managed together with the erase count value.

<Physical Block Structure>

FIG. 5 is a view showing one example of a physical block structure. A physical block 501 is configured with a plurality of physical pages 502 that are a unit which can be write-accessed. Each physical page 502 is configured with a user data area 503 that stores write data from a host and a redundant data area 504 that stores optional data other than the write data. The erase count value with respect to a physical block is written in an optional area of the redundant data area 504 when data write to the physical page 502 is carried out. This area is used as an erase count counter 505.

<Selecting Processing of Physical Block that can be Optionally Used>

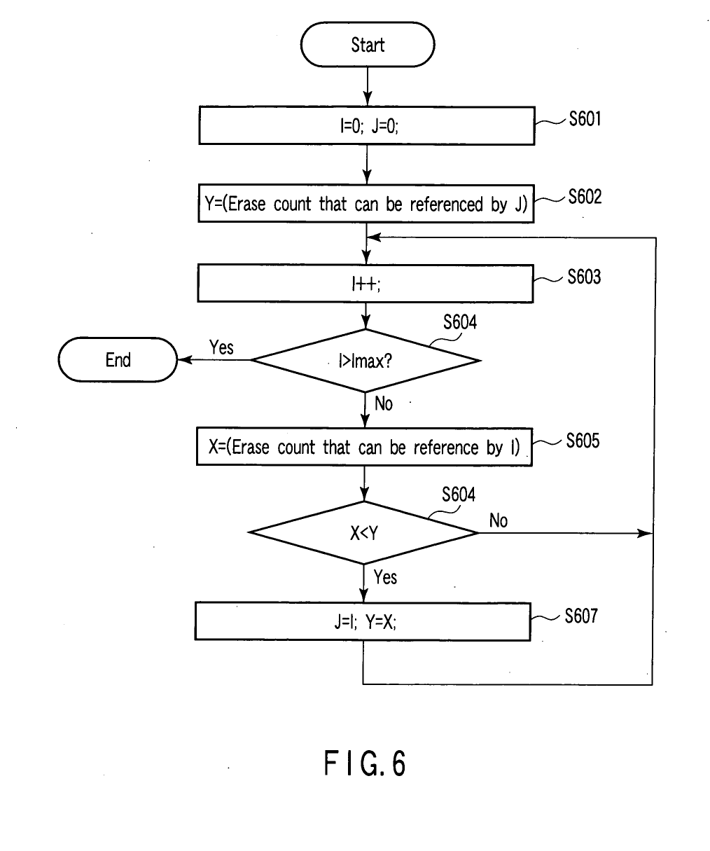

FIG. 6 is a flowchart showing an operation when selection of a physical block that can be optionally used is carried out. When a search for a physical block is started, (I, J) is initialized. That is, in step S601, I=0 and J=0 are set, and an index 00 in FIG. 4 is set as a starting point (step S601).

A variable I indicates a value of an index 401 (refer to FIG. 4), and a variable J indicates a value of the index 401 in which a physical block of a maximum physical block erase count is stored.

A variable Y is a value of erase count data 403 of a physical block that can be referenced in the index 401 shown by the variable J (step S602). The variable I for sequentially searching for physical blocks is the number of physical blocks that can be optionally used. This variable I is sequentially incremented to an I max value (steps S603 and S604). A variable X is a value of the erase count data 403 of physical blocks that can be referenced in the index 401 shown by the variable I (step S605).

The variables X (value of a searched physical block) and Y (maximum value) are compared (step S606), and a smallest physical block erase count value (for example, 00000A99h) and an index value (for example, a) thereof at the time of the current searching are stored as the variables Y and J (step S607). Next, the operation returns to step S603, and steps from S604 to S607 are executed. In this manner, physical blocks with a lower physical block erase count are extracted from a group of physical blocks that can be optionally used.

A physical block having maximum erase count information is identified by comparison processing of erase count information in advance.

In addition, with respect to the identifying processing of the selected physical blocks described above, a variety of embodiments are possible, as long as an erase count of a physical block is averaged. Therefore, the configuration may be such that an average value of erase frequencies of a plurality of physical blocks is obtained and a physical block having an erase count equal to or below the average value is selected.

Alternatively, a frequently-used logical address and a rarely-used logical address are stored, and in accordance with a use count of a logical address, it may be switched to a selecting method for selecting a physical address corresponding to this logical address. For example, with respect to a logical address with a high use count, for example, a logical address with a use count exceeding a certain threshold value, processing to associate a physical address with a low erase count is carried out. By contrary, with respect to a logical address with a low use count, for example, a logical address with a use count below or equal to a certain threshold value, processing (updating processing of logical/physical block address conversion table) for associating a physical address with a high erase count is carried out. This updating processing of the logical/physical block address conversion table is carried out when a data write command is sent from a host, or after an updating processing of a file system is carried out.

<Flowchart that Explains Basic Operation>

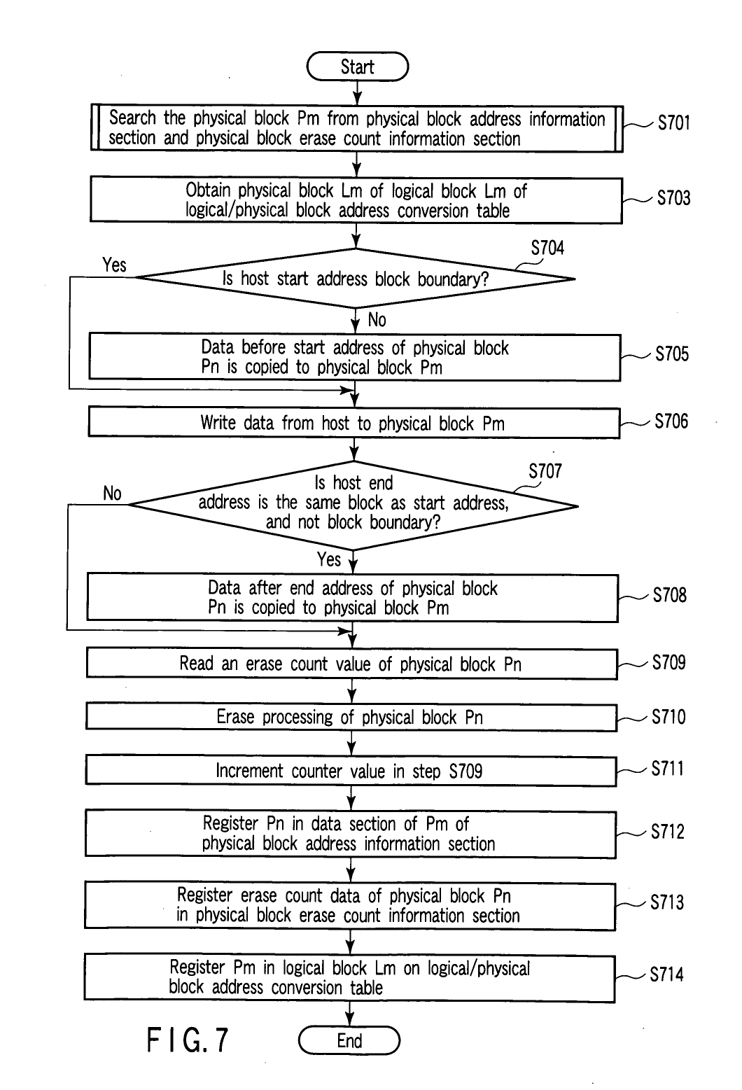

FIG. 7 is a flowchart that explains a basic operation of the present invention. The following description will be made with reference to FIGS. 7 and 1. Now, it is assumed that a write command from a host is input via the host interface 104.

The MPU 102 has a command analysis section 102f, an integrated processing section 102x, a physical block use state management section 102c, a physical block erase count management section 102d, and a physical-logical block address conversion table management section 102b. These sections execute data processing in an integrated manner.

The MPU 102 analyzes a host command, and searches for an appropriate physical block Pm that can be optionally used by referencing the physical block use state information section 103c and the physical block erase count information section 103d (step S701: also described in FIG. 6). The physical block use state management section 102c, the physical block erase count management section 102d, and the integrated processing section 102x execute data processing in an integrated manner.

Next, a table of the logical/physical block address conversion table information section 103b is referenced, and a current physical block Pn corresponding to a logical block Lm in which a host needs to write is obtained (step S703). Logical/physical block address conversion table management section 102b and the integrated processing section 102x execute data processing in an integrated manner.

Next, whether a host start address that is a write start position designated by a host is a physical block boundary or not is determined (step S704). If the host start address is not the block boundary, data (data in Pn) before a start address of the physical block Pn is copied in the physical block Pm first (step S705). In this manner, loss of data is prevented. After the processing, the operation moves to step S706, and data write from a host is executed.

In the case that the host start address in which data needs to be written is a physical block boundary, the step (step S705) is skipped, and data from a host is written in the physical block Pm (step S706).

Next, whether a host end address is in the same block as the start address and is not a block boundary is determined (step S707).

If the host end address is not at a boundary, data after an end address of the physical block Pn is copied to the physical block Pm (step S708). Next, the physical block Pn is registered in the physical block use state information section 103c and the physical block erase count information section 103d as a physical block that can be optionally used. That is, a value of the erase count counter 505 of the physical block Pn is read (step S709), erase processing of the physical block Pn is carried out (step S701), and further, erase count data of the physical block Pn is updated (step S711).

Next, the physical block address data 402 and the physical block erase count data 403 of Pn is registered in an information section of Pm of the physical block use state information section 103c (refer to a numerical number 404 enclosed by a dotted line in FIG. 4) (steps S712, S713). Further, Pm is registered as physical block address data corresponding to the logical block Lm of the logical/physical block address conversion table information section 103d (step S714, and refer to a numerical number 303 enclosed by a dotted line in FIG. 3). In the case a subject of write access from a host exceeds one block, the operation from step S701 is repeated further.

### Other Embodiments

In the above embodiment, it was described that the logical/physical block address conversion table, the physical block use state information, and the physical block erase count information are stored in the RAM 103. However, it is obvious that these pieces of information may be stored in a part of an area of the nonvolatile memory device 101. Then, when the power of a device is turned on, these pieces of information may be developed in the RAM 103.

### Summary of Important Section of the Above Embodiment

As described above, an aspect of the present invention is a memory control method of controlling a nonvolatile memory with a limit of an erase count in units of physical blocks and/or a programming count by a random access memory and a control unit. Here, the logical/physical block address conversion table that associates a logical block address in a logical address space used by a host device with a physical block address of the nonvolatile memory can be generated. In addition, at least the physical block use state information that includes information showing whether a physical block of the nonvolatile memory is associated by the logical/physical block address conversion table or not can be generated. Further, the physical block erase count information including erase count information of the physical block can be generated. Next, erase count information is read from among a plurality of physical blocks of which a logical block address and physical block address are not associated, and a physical block satisfying a predetermined condition set in advance by the erase count information can be selected as a selected physical block. Then, a physical block address of the selected physical block is registered in the logical/physical block address conversion table.

In addition, in the present invention, data erase can be carried out further with respect to a physical block corresponding to a former physical block address that previously existed at a position where a physical block address of the selected physical block is registered in the logical/physical block address conversion table. Then, when the data erase is carried out with respect to the physical block that corresponds to the former physical block address, an erase count value of a redundant section of the physical block is updated.

In addition, in the present invention, when the selected physical block is further searched for, pieces of erase count information read out from the redundant sections of a plurality of the physical blocks are compared, a piece of the erase count information having a smallest value is determined, and a physical block having this piece of the erase count information may be set as the selected physical block. This case is suitable in a case where a logical block that is designated as a destination for data write is a logical block that is frequently used, and a use count exceeds a certain threshold value.

In addition, in the present invention, when a selected physical block is searched for, the pieces of erase count information read out from the redundant sections of a plurality of the physical blocks are compared, a piece of the erase count information having a smallest value is determined, and a physical block having this piece of the erase count information may be set as the selected physical block. This case is suitable in a case where a logical block that is designated as a destination for data write is a logical block that is rarely used (mainly used exclusively for readout), and a use count is below or equal to a certain threshold value.

The present invention is not limited to the above embodiments as they are, and may be embodied by modifying components in a range not departing from the spirit thereof at an implementation stage. In addition, a variety of inventions can be formed by a proper combination of a plurality of the components described in the above embodiment. For example, some of the components may be eliminated from all of the components shown in the embodiments. Further, the components extending different embodiments may be combined properly.

That is, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device of a nonvolatile memory, comprising:
a logical/physical block address conversion table information section which associates a logical block address of a logical address space used by a host device with a physical block address of a physical block of a nonvolatile memory;
a physical block use state information section which stores information showing whether a physical block is associated with a logical block by the logical/physical block address conversion table information section or not;
a physical block use state management section and a physical block erase count management section which use erase count information of a physical block of which the physical block address and the logical block address are not associated, and select a physical block as a first physical block when this physical block satisfies a predetermined condition set related to the erase count information; and
a logical/physical block address conversion table management section which associates a physical block address of the first physical block with a logical block address, and registers the associated physical block address in the logical/physical block address conversion table information section.

2. The control device of a nonvolatile memory according to claim 1, wherein
the logical/physical block address conversion table management section and the physical block erase count management section carry out data erase with respect to a second physical block corresponding to an old physical block address which previously existed at a position where a physical block address of the first physical block is registered in the logical/physical block address conversion table information section, and
an erase count value in a redundant section of the old physical block is updated when the data erase is carried out with respect to a physical block corresponding to the old physical block address.

3. The control device of a nonvolatile memory according to claim 1, wherein
the physical block use state management section and the physical block erase count management section manage pieces of erase count information read out from redundant sections of a plurality of the physical blocks, determine a piece of the erase count information having a smallest value, and set a physical block having this piece of the erase count information as the first physical block.

4. The control device of a nonvolatile memory according to claim 1, wherein
the physical block use state management section and the physical block erase count management section manage pieces of erase count information read out from redundant sections of a plurality of the physical blocks, determine a piece of the erase count information with a largest value, and set a physical block having this piece of the erase count information as the selected physical block.

5. A control method of a nonvolatile memory which controls, a nonvolatile memory device with a limit of an erase count in a physical block unit and/or a programming count, by a random access memory and a control section, wherein the control method comprising;
generates a logical/physical block address conversion table which associates a logical block address of a logical address space used by a host device with a physical block address of the nonvolatile memory,
generates physical block use state information including information showing whether a logical block is associated with a physical block by the logical/physical block address conversion table,
uses pieces of erase count information of a physical block of which the logical block address and the physical block address are not associated and selects a physical block as a first physical block satisfying a predetermined condition set related to the erase count information, and
associates a physical block address of the first physical block with a logical block address and registers the associated physical block address in the logical/physical block address conversion table.

6. The control method of a nonvolatile memory according to claim 5, wherein
data erase is further carried out with respect to a second physical block corresponding to an old physical block address which previously existed at a position where a physical block address of the selected physical block is registered in the logical/physical block address conversion table, and
when the data erase is carried out with respect to a physical block corresponding to the old physical block address, an erase count value of a redundant section of the old physical block is updated.

7. The control method of a nonvolatile memory according to claim 5, wherein
when the first physical block is searched for, pieces of erase count information read out from redundant sections of a plurality of the physical blocks are used, a piece of the erase count information having a smallest value is determined, and a physical block having this piece of the erase count information is set as the first physical block.

8. The control method of a nonvolatile memory according to claim 5, wherein
when the first physical block is searched for, pieces of erase count information read out from redundant sections of a plurality of the physical blocks are used, a piece of the erase count information having a smallest value is determined, and a physical block having this piece of the erase count information is set as the first physical block.

9. A storage device having a host interface which receives data including a command from a host, a random access memory, a nonvolatile memory device, and a micro processing unit which analyzes the command and controls the random access memory and the nonvolatile memory device in an integrated manner, comprising:
a logical/physical block address conversion table information section which associates a logical block address of a logical address space used by the host device with a physical block address of the nonvolatile memory;
a physical block use state information section which stores information showing whether a physical block is associated with a logical block by the logical/physical block address conversion table;
a physical block use state management section and a physical block erase count management section which use erase count information of a physical block of which the logical block address and the physical block address are not associated, and select a physical block as a first physical block which satisfies a predetermined condition set related to the erase count information; and
a logical/physical block address conversion table management section which associates a physical block address of the first physical block with a logical block address, and registers the associated physical block address in the logical/physical block address conversion table.

10. The storage device according to claim 9, wherein
the logical/physical block address conversion table management section and the physical block erase count management section carry out data erase with respect to a physical block corresponding to an old physical block address which previously existed at a position where a physical block address of the first physical block is registered in the logical/physical block address conversion table, and
an erase count value of a redundant section of the old physical block is updated when the data erase is carried out with respect to a physical block corresponding to the old physical block address.

11. The storage device according to claim 9, wherein
the physical block use state management section and the physical block erase count management section manage pieces of erase count information read out from redundant sections of a plurality of the physical blocks, determine a piece of the erase count information with a smallest value, and set a physical block having this piece of the erase count information as the first physical block.

12. The storage device according to claim 9, wherein
the physical block use state management section and the physical block erase count management section manage pieces of erase count information read out from redundant sections of a plurality of the physical blocks, determine a piece of the erase count information with a largest value, and set a physical block having this piece of the erase count information as the selected physical block.
